(19) United States
(12) Patent Application Publication
(10) Pub. No.: US 2003/0102404 A1
(43) Pub. Date: Jun. 5, 2003

(54) Non-latex balloon and method for producing the same

(75) Inventor: Nobuhiko Yabe, Sumida-ku (JP)

Correspondence Address: JORDAN AND HAMBURG LLP, 122 EAST 42ND STREET, SUITE 4000, NEW YORK, NY, 10168, US

(73) Assignee: Shinei Gomu Kabushikigaisha, Sumida-ku (JP)

(21) Appl. No.: 10/292,334

(22) Filed: Nov. 12, 2002

(30) Foreign Application Priority Data
Dec. 5, 2001 (JP) 370850/2001

(51) Int. Cl. B64B 1/58; B64B 1/40; F41J 9/08

(52) U.S. Cl. 244/31

(57) ABSTRACT

A non-latex balloon 10 having a double balloon structure, having an outer balloon made of a pair of films 21, 22 for the outer balloon of which the peripheral edges 23 are heat-sealed; and an inner balloon disposed in the outer balloon, likewise made of a pair of films for the inner balloon of which the peripheral edges are heat-sealed. A first check valve 40 to fill a gas into the outer balloon 20, is integrally bonded to the outer balloon by heat-sealing of the films 21, 22 for the outer balloon; and a second check valve 50 to fill a gas into the inner balloon 30 is inserted and disposed between the films of the outer balloon 20 and between the films of the inner balloon 30, and integrally bonded to respective balloons by heat-sealing of the films. On the inner sides of the respective check valves 40, 50, non-heat sealing portions 44, 54, 55 are provided to secure gas permeation.

### FIELD OF THE INVENTION

The present invention relates to a non-latex balloon having decorative properties and design properties, useful for, for example, toy products and advertisement. More particularly, it relates to a non-latex balloon having a double balloon structure wherein an inner balloon is provided in an outer balloon, and a method for producing it.

### BACKGROUND OF THE INVENTION

As non-latex balloons having decorative properties and design properties, spherical or disk-like non-latex (film) balloons prepared by heat-sealing the peripheral edges of two sheets of circular films, in which a gas lighter than air such as helium is filled therein, has heretofore been known.

In order to allow the non-latex balloon having e.g. helium filled therein to float for a longer time as compared with conventional latex or rubber balloons, multilayer films having a light weight and a gas barrier property are used for the non-latex balloon and the peripheral edges of the films are sealed by heat-sealing. By such a structure, it is possible to prevent leakage of the internal gas through the films, resulting in deflation of the balloon, for a long period of time. Further, since it is possible to e.g. freely print the surface of the film, the non-latex balloon has excellent decorative properties. Moreover, it has also been practiced to impart a gas barrier property and a decorative properties at the same time by providing a metal deposition film as a gas barrier layer.

On the other hand, as the non-latex balloon, in order to further improve the decorative properties and design properties, a so-called double balloon is known of which the outer balloon is wholly or partly made of a transparent film and the inner balloon is disposed in the outer balloon.

For example, JP-A-2000-61158 discloses as a double balloon which is made of a film material having a high gas barrier property to lessen the leakage of a gas and prolong the life as a non-latex balloon, a composite plastic film balloon constituted by an outer skin made of a transparent plastic film balloon-like body and an inner skin made of a separate plastic film balloon-like body, wherein the outer skin is made of a laminate film of a gas barrier co-extruded plastic film or a gas barrier plastic film/a linear low-density polyethylene film, and the inner skin is made of a laminate film of a gas barrier plastic film/a linear low-density polyethylene film or a laminate film of an aluminum metal deposition nylon film/a linear low density polyethylene film.

Further, check valves by which a gas can easily be filled into a double balloon and leakage of the gas from a filling inlet due to backflow after filling the gas can be prevented, have been proposed. For example, Japanese Utility Model Publication No. B-7-31832 discloses, as an integrally formed gas-filling valve for a double balloon, a gas-filling valve for a double balloon toy product which comprises a first tubular body having its basis end portion closed, to which first, second and third flanges are provided; and a second tubular body having its basis end portion closed, wherein said second tubular body is fixed to the second flange, and passes through the third flange and projects in parallel to the first tubular body; transverse holes are provided in the first tubular body between the first and second flanges and in the second tubular body between the second and third flanges; an inlet portion of an inner balloon is attached to the second flange; an inlet portion of an outer balloon is attached to the third flange; and the first and second tubular bodies are projected from the balloon.

However, among the above prior art, in the non-latex balloon having the double balloon structure of JP-A-2000-61158, although it is possible to lessen the leakage of gas from the films by using a film material having a high gas barrier property, it is necessary to conduct sealing by e.g. tying a gas-filling inlet, since no valve body is employed. Accordingly, the gas tends to easily leak out of the gas-filling inlet and the gas-filling operation is necessarily cumbersome. Further, since the double balloon structure needs another step for inserting the inner balloon into the outer balloon, there is a drawback that the production process will become complicated.

Further, in the gas-filling valve in Japanese Utility Model Publication No. B-7-31832, although the gas-filling operation is easy, the check valve has such a structure that the transverse holes are closed by utilizing the return by the elasticity of a rubber balloon, whereby this utility model can not be applied to non-latex balloons. Moreover, since the valve body is a molded product, it is necessary to conduct another separate step for installing the valve body to the double balloon and thus its production process is also complicated and the production cost is high.

### SUMMARY OF THE INVENTION

Under such circumstances, it is an object of the present invention to provide a film balloon having a double balloon structure for which filling of gas and sealing can easily be conducted, and a method for producing it in which its production process is easy and simple and it can be produced with a low cost.

In order to accomplish the above object, the present invention provides a non-latex balloon having a double balloon structure, which comprises:

an outer balloon made of a plurality of films of which peripheral edges are heat-sealed,

an inner balloon disposed in the outer balloon, made of a plurality of films of which the peripheral edges are heat-sealed,

a first check valve of a flat tubular film of which both ends are open-ended, to fill a gas into the outer balloon, wherein the first check valve is disposed between the films of the outer balloon and inwardly inserted through the peripheral edges of the outer balloon and integrally bonded to the outer balloon by heat-sealing the films of the outer balloon, and defines a gas passageway to the inside of the outer balloon, and

a second check valve of a flat tubular film of which both ends are open-ended, to fill a gas into the inner balloon, wherein the second check valve is disposed between the films of the outer balloon and inwardly inserted through the peripheral edges of the outer balloon, and disposed between the films of the inner balloon and inwardly inserted through the peripheral edges of the inner balloon, and wherein the second check valve is integrally bonded to the outer balloon and the inner balloon by heat-sealing the films of the outer balloon and the inner balloon, respectively, and defines a gas passageway to the inside of the inner balloon.

In the non-latex balloon of the present invention, since the second check valve is integrally bonded by the heat-sealing of the films of the outer and inner balloons respectively, it is possible to inflate the inner balloon easily by filling a gas into the inner balloon through the second check valve. Further, under such state, by filling a gas into the outer balloon through the first check valve, the outer balloon can also be inflated easily. As a result, a non-latex balloon having a double balloon structure wherein an inner balloon is disposed in an outer balloon and connected to the outer balloon via a second check valve. Here, since the first and second check valves are separately disposed, the position for inserting the inner balloon can be freely selected and it is possible to provide a plurality of inner balloons therein. Further, since the check valve is a flat and tubular film, there is no necessity to use a molded valve as a valve body and such balloon can be made at a low cost.

In a preferred embodiment of the non-latex balloon of the present invention, each of internal sides of the first and second check valves has a non-heat sealable portion to secure the gas passageway at at least a position or positions at which external sides of the first and second check valves are heat-sealed to the peripheral edges of the films of the outer and inner balloons, respectively.

In this embodiment, when the peripheral edges of the films of the outer balloon and the inner balloon are heat-sealed, the internal sides of the check valves are not concurrently heat-sealed since a non-heat sealable portion is provided in each of the check valves, whereby the production of the outer balloon and the inner balloon can be made easily.

In another preferred embodiment of the non-latex balloon of the present invention, the non-heat sealable portion is formed by coating a heat resistant resin or ink.

In this embodiment, even if the internal side of the film constituting the check valve is a heat-sealable material, the non-heat sealable portion can securely be provided only at the desired portion on the internal side of the check valve.

On the other hand, the method for producing the non-latex balloon of the present invention is a method for producing a non-latex balloon of a double balloon structure comprising an outer balloon made of a plurality of films of which peripheral edges are heat-sealed and an inner balloon disposed in the outer balloon, made of a plurality of films of which peripheral edges are heat-sealed, which comprises:

a step for preparing an inner balloon by putting together films for the inner balloon; disposing a second check valve of a flat tubular film of which both ends are open-ended, between the peripheral edges of the films for the inner balloon so that the second check valve is inwardly inserted through the peripheral edges of the films for the inner balloon; and heat-sealing the peripheral edges of the films for the inner balloon which are put together, in such a state that a sealing-preventive means is provided on an internal side of the film of the second check valve to form the inner balloon having the second check valve integrally bonded; and

a step for preparing an outer balloon by putting together films for the outer balloon; disposing the inner balloon between the films for the outer balloon; arranging the second check valve so that it extends outwardly from the peripheral edges of the films for the outer balloon; disposing a first check valve of a flat tubular film of which both ends are open-ended so that the first check valve is inwardly inserted through the peripheral edges of the films of the outer balloon; and heat-sealing the peripheral edges of the films for the outer balloon in such a state that sealing-preventive means are provided on the internal sides of the films of the first and second check valves, to form the outer balloon having the first and second check valves integrally bonded to the outer balloon.

In this production method, when the films for the inner balloon are heat-sealed, a sealing-preventive means is provided on the internal side of the film of the second check valve, and when the films for the outer balloon are heat-sealed, sealing-preventive means are provided on the internal sides of the films of the first check valve and second check valve, whereby it is possible to easily form the non-latex balloon with good working efficiency while securing gas passageways for the respective check valves. Further, when the outer balloon is formed, the inner balloon having the second check valve bonded thereto can concurrently be inserted and integrated, whereby it is not necessary to install the check valves after the formation of the double balloon and its production process can be simplified.

Further, in the method for producing the non-latex balloon of the present invention, it is preferred that the sealing-preventive means is made of a non-heat sealable portion formed on the internal sides of the first and second check valves and at at least a position or positions at which external sides of the first and second check valves are heat-sealed to the peripheral edges of the outer and inner balloons, respectively.

In this embodiment, when the peripheral edges of the films of the outer balloon and the inner balloon are heat-sealed, it is not necessary to preliminarily insert a heat resistant film, resin plate, etc. in the check valve, whereby the production process can further be simplified.

In the method for producing the non-latex balloon of the present invention, it is further preferred that the non-heat sealable portion is formed by coating a heat resistant resin or ink.

In this embodiment, even if the internal side of the film constituting the check valve is a heat-sealable material, the non-heat sealable portion can securely be provided only at the desired portion on the internal side of the check valve.

### BRIEF DESCRIPTION OF THE DRAWINGS

FIG. 1 is a perspective view showing an embodiment of a non-latex balloon of the present invention.

FIG. 2 is a perspective view showing a step for putting together a pair of belt-like films which constitute a second check valve of the above non-latex balloon.

FIG. 3 is a perspective view of the second check valve of the above non-latex balloon.

FIG. 4 is a perspective view showing a step for forming an inner balloon of the above non-latex balloon.

FIG. 5 is a perspective view of the inner balloon to which the second check valve is bonded in the above non-latex balloon.

FIG. 6 is a perspective view showing the step for forming an outer balloon of the above non-latex balloon.

FIG. 7 is a perspective view before filling a gas into the above non-latex balloon.

FIG. 8 is a schematic view illustrating the state when the gas is filled in the above non-latex balloon.

### DESCRIPTION OF THE PREFERRED EMBODIMENTS

Hereinafter, embodiments of the present invention will be described with reference to the attached drawings.

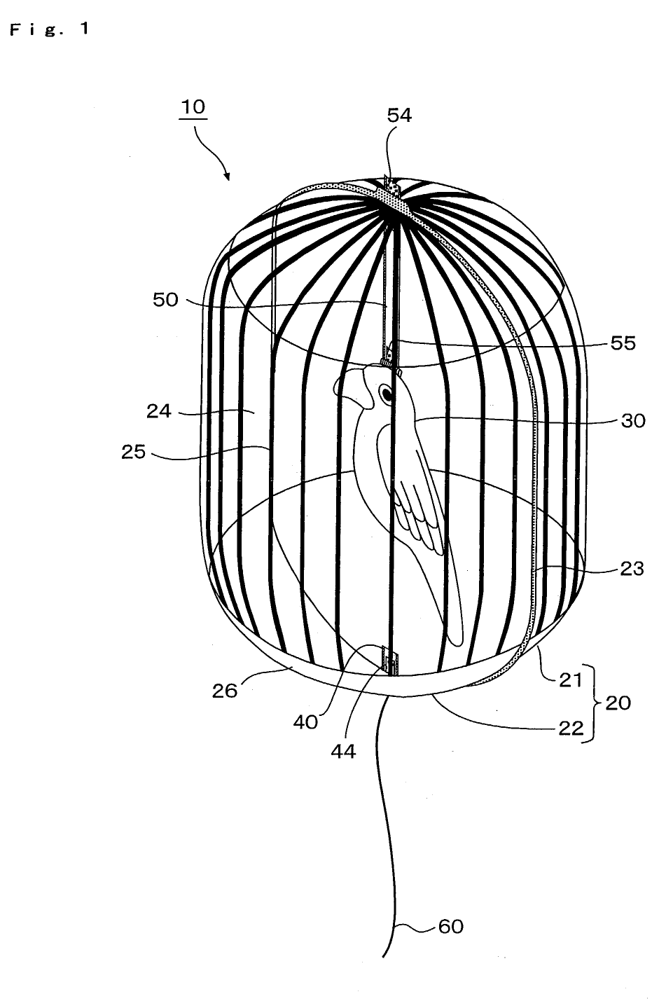

As shown in FIG. 1, a non-latex balloon 10 of the present invention is constituted by an outer balloon 20, an inner balloon 30, a first check valve 40 for filling a gas into the outer balloon and a second check valve 50 for filling a gas into the inner balloon. Numeral 60 is a string for keeping the balloon.

The outer balloon 20 is formed into a shape of birdcage as a whole i.e. a cylindrical shape of which both ends are formed into a hemispherical shape. The outer balloon 20 is formed by putting together a pair of oval-shaped films for the outer balloon 21, 22, and heat-sealing the peripheral edges 23 thereof. The films for the outer balloon 21, 22 are made of transparent films, and on their surfaces, printed portions 25, 26 having the design of the birdcage are provided. The inner balloon 30 can be seen through the transparent portion 24.

The films for the outer balloon 21, 22 may be completely transparent films or translucent films so far as the inner balloon 30 can be seen through the films from the outside. Further, as a method for imparting the design property and barrier property, a metal deposition layer of aluminum or the like may be provided on a part of the films.

As the material for the films for the outer balloon 21, 22, there is no particular limitation so far as the films are heat-sealable. However, it is preferred that the films have a gas barrier property so as to prevent deflation of the balloon due to the gas permeation of the gas through the films. As such a heat-sealable film having the gas barrier property, conventionally known laminate films containing at least a heat-sealable layer and a gas barrier layer, may, for example, be mentioned. As a resin for the heat-sealable layer, for example, polyethylene, polypropylene, an ethylene/vinyl acetate copolymer (EVA) and the like may be mentioned. As the gas barrier layer, for example, polyamide, polyethylene terephthalate, an ethylene/vinyl alcohol copolymer, polyvinylidene chloride and the like may be mentioned. The resins may be laminated in a film state, or may be coated on the surface. Further, a deposition layer of a metal or a metal oxide may preferably be used as the gas barrier layer. As the metal, aluminum may be used, and as the metal oxide, silica, alumina and the like may be used. Further, the above laminate film may be constituted by at least 3 layers.

The shape of the outer balloon 20 is not particularly limited, and may be spherical, prism or the like, in addition to the tubular shape as shown in FIG. 1. The films for the outer balloon 21, 22 have such a shape that the desired shape is obtainable when the peripheral edges are heat-sealed to form a balloon and a gas is filled therein to inflate the balloon. Further, the films constituting the outer balloon 20 may be two or more in number, and, for example, when a polyhedron is formed, it may be constituted by a plurality of films.

The inner balloon 30 is formed by heat-sealing a pair of films for the inner balloon 31, 32 at their peripheral edges as in the case of the outer balloon 20, and disposed so that it hangs from the upper portion inside the outer balloon 20 via a second check valve 50 which communicates a peripheral edge 23 of the outer balloon 20 and a peripheral edge 33 of the inner balloon 30.

The films for the inner balloon 31, 32 is not particularly limited so far as they are heat-sealable at their peripheral edges 33, and films similar to the films for the outer balloon 21, 22 may be used. Further, the films for the outer balloon 21, 22 and the films for the inner balloon 31, 32 may be the same or different in the material. Moreover, on the surfaces of the films for the inner balloon 31, 32, printing or metal deposition may be applied.

The second check valve 50 is sandwiched between the films for the outer balloon 21, 22 at its basis end portion, and inserted into the outer balloon 20 through its peripheral edge 23. Further, the second check valve 50 is sandwiched between the films for the inner balloon 31, 32 at its forward end portion, and inserted into the inner balloon 30 through its peripheral edge 33. And, the check valves are integrally bonded to the films when the films for the outer balloon 21, 22 and the films for the inner balloon 31, 32 are heat-sealed, respectively, and at the same time, the gas passageway toward the inside of the inner balloon 20 can be secured.

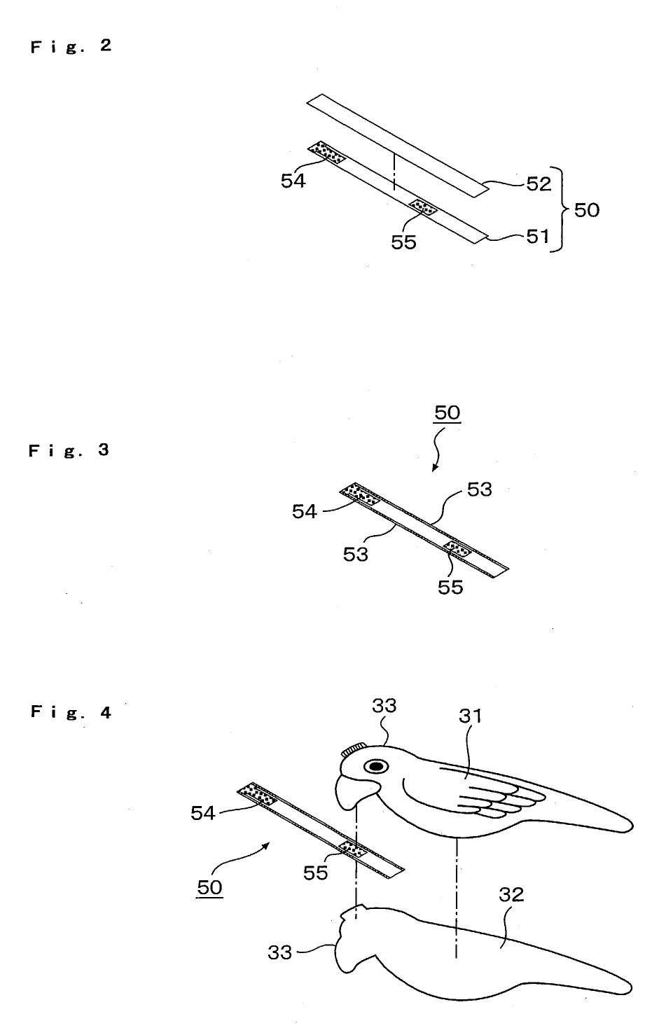

The second check valve 50 is a flat tubular film having both ends open-ended which is obtainable by putting together a pair of belt-like films 51, 52 as shown in FIGS. 2 and 3, and bonding both sides 53 by melting, adhering or the like. The belt-like films 51, 52 may be any one so far as they can be integrally bonded to the films for the outer balloon 21, 22 and the films for the inner balloon 31, 32 by heat-sealing, and preferably the same material as the heat-sealable layers of the films 21, 22, 31 and 32.

On the internal side of the belt-like film 51 to be put together with another one, non-heat sealable portions 54, 55 are formed at two positions e.g. a position at which heat-sealing with the peripheral edge 23 of the outer balloon 20 is to be carried out and a position at which heat-sealing with the peripheral edge 33 of the inner balloon 30 is to be carried out, to secure a gas passageway. In the case of this embodiment, the non-heat sealable portions 54, 55 are formed by coating a heat resistant resin or ink.

As the heat resistant resin, a fluororesin, a silicone resin and the like may be mentioned. As the heat-resistant ink, an ink containing silica, alumina, titanium oxide or the like, and the above-mentioned heat resistant resin as a binder, may be mentioned. Further, other than the heat resistant resin or ink, the non-heat sealable portions may be formed by, for example, providing a thin layer of e.g. a metal or a metal oxide, by e.g. deposition.

Further, in the present invention, the non-heat sealable portions may be formed by inserting a heat resistant film or plate of e.g. a fluororesin at the time of heat-sealing, and removing it after the heat-sealing. Furthermore, the second check valve 50 may be a preliminarily molded tube-like product, i.e. a multiplayer tube of which the internal side is a heat resistant layer and the external side is a heat-sealable layer, whereby a non-heat sealable portion is provided on the internal side.

On the other hand, the first check valve 40 is disposed at the lower portion of the non-latex balloon 10 to fill a gas into the outer balloon 20. It is disposed between the films for the outer balloon 21, 22, inwardly inserted via the peripheral edge 23 of the outer balloon 20, and is integrally bonded by heat-sealing of the films for the outer balloon 21, 22 and at the same time, a gas passageway into the outer balloon 20 is formed.

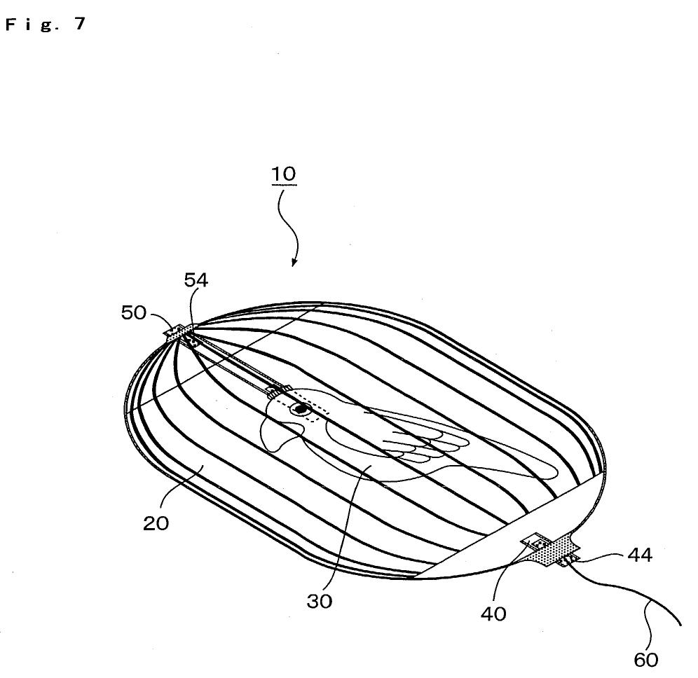

The first check valve 40 basically has the same structure as the second check valve 50 provided that as shown in FIG. 6, the difference is only the point that a non-sealable portion 44 is formed only at the position at which a heat-sealing portion is formed on the peripheral edge 23 of the outer balloon 20, and other structure and material are the same as the second check valve 50.

Then, a method for producing this non-latex balloon 10 will be described.

First, as shown in FIG. 2, a pair of belt-like films 51, 52 are put together, both side edges 53 are heat-sealed or adhered, to form a second check valve 50 as the flat tubular film of which both ends are open-ended. At that time, on the internal side of one film 51, as mentioned above, non-heat sealable portions 54, 55 formed by coating a heat resistant resin or ink are provided.

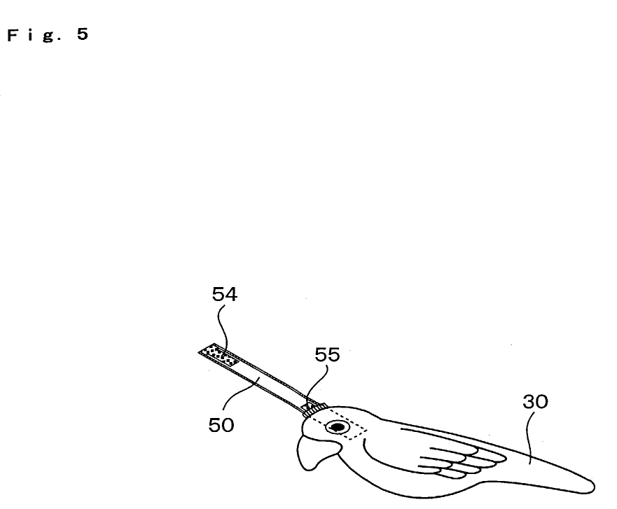

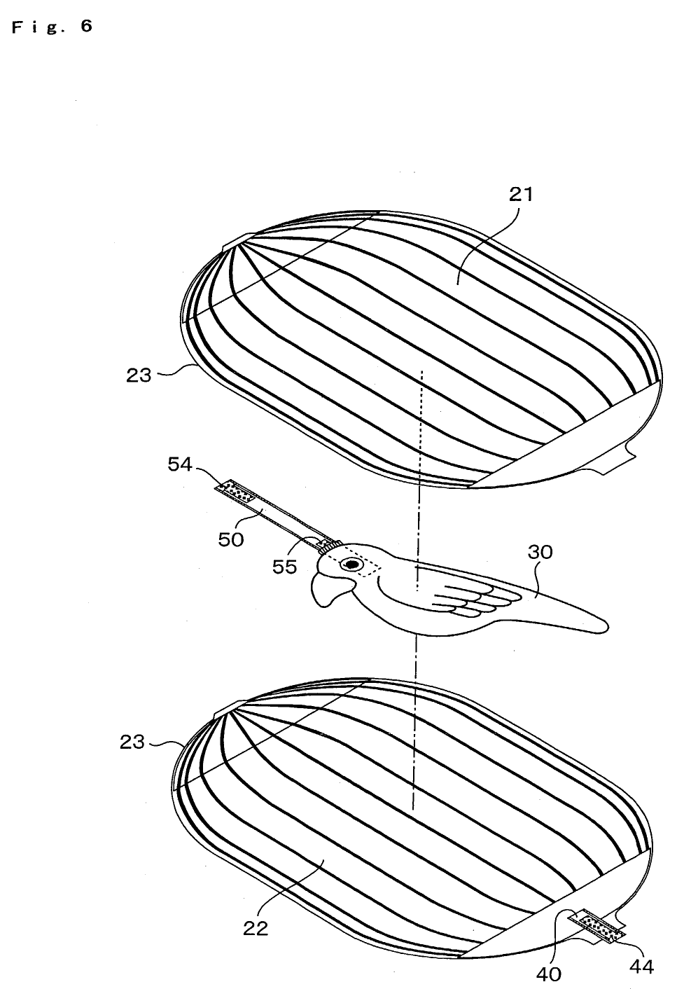

Then, as shown in FIG. 4, a pair of films for the inner balloon 31, 32 are put together, the second check valve 50 is sandwiched therebetween so that it is inwardly inserted via the peripheral edges 33 of the films. At that time, the non-heat sealable portion 55 is disposed so that it will overlap with sealing portions of the films for the inner balloon 31, 32. And, while keeping this state, peripheral edges 33 of the films for the inner balloon 31, 32 which are put together are heat-sealed, to form an inner balloon 30 having the second check valve 50 integrally bonded thereto as shown in FIG. 5. Here, as the heat-sealing means, there is no particular limitation, and conventional methods such as heat-sealing, impulse sealing, fuse cut sealing and ultrasonic sealing may be used. At that time, in the inside of the second check valve 50, the non-heat sealable portion 55 is provided and thus a gas passageway to fill the air is secured.

Then, as shown in FIG. 6, films for the outer balloon 21, 22 are put together, the inner balloon 30 having the second check valve 50 integrally bonded thereto is disposed between these films 21, 22, and the second check valve 50 is disposed so that it extends outwardly from the peripheral edge 23 of the films for the outer balloon, and at the same time, the first check valve 40 is disposed between these films so that it is inwardly inserted from the peripheral edges 23 of the films for the outer balloon.

Here, the second check valve 50 is disposed so that it overlap with the sealing portions of the films for the outer balloon 21, 22 at the non-heat sealable portion 54, and likewise, the first check valve 40 is disposed so that it overlap with the sealing portions of the films for the outer balloon 21, 22 at the non-heat sealable portion 44.

And, while keeping this state, the peripheral edges 23 of the films for the outer balloon 21, 22 which are put together, are heat sealed to form the outer balloon 20 having the first and second check valves 40, 50 integrally bonded as shown in FIG. 7, by which the non-latex balloon 10 is completed. At that time, in the first and second check valves 40, 50, the non-heat sealable portions 44, 54 are provided at the positions at which heat-sealing is to be carried out at the peripheral edges 23 of the films for the outer balloon 21, 22, whereby a gas passageway for filling a gas is secured.

As mentioned above, according to the production method of the present invention, when the outer balloon 20 is formed, the inner balloon 30 having the second check valve 50 bonded thereto can be concurrently inserted and disposed, and integrally formed, whereby a step for installing a check valve after formation of the double balloon or a step for inserting an inner balloon into an outer balloon, is no longer required, and the production process can be simplified.

Then, the action of the non-latex balloon 10 of the present invention will be described.

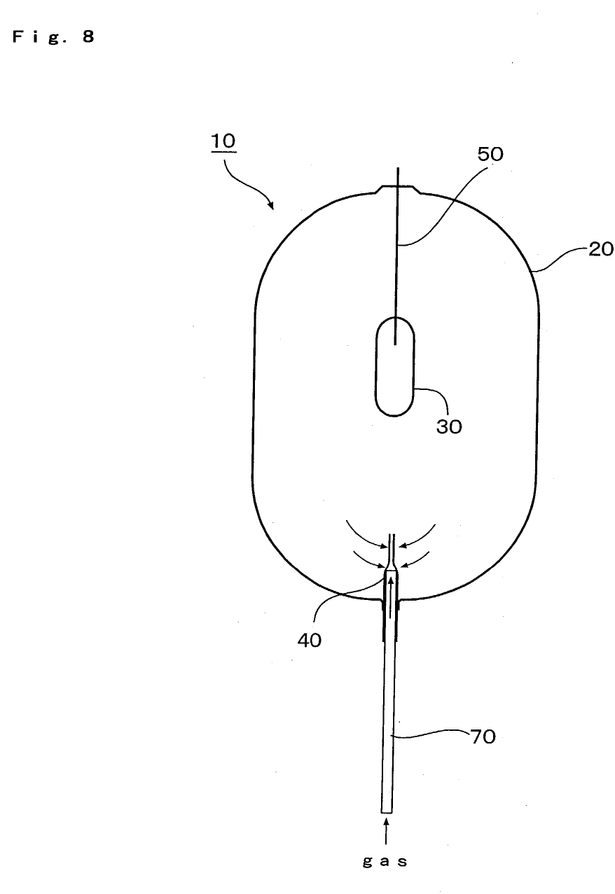

The non-latex balloon 10 can be inflated by inserting straw-like gas-filling tools 70 into the first check valve 40 and the second check valve 50, and filling a gas such as helium through these check valves as shown in FIG. 8. And, after inflating the balloon, upon removal of the gas-filling tools 70, the tubular bodies of the check valves are closed by the pressure in the balloon and thus no leakage of the gas due to backflow is caused.

In actual, it is preferred to at first, insert the straw-like gas-filling tool 70 into the second check valve 50 for the inner balloon 30 and inflate the inner balloon 30, and then insert the gas-filling tool 70 into the first check valve 40 for the outer balloon 20 and inflate the outer balloon 20.

The gas to be filled in the inner balloon 30 is not necessarily the same as the gas to be filled in the outer balloon 20. For example, as in this embodiment, when the inner balloon 30 hangs from the upper portion of the outer balloon 20, helium may be filled in the outer balloon 20 and normal air may be filled in the inner balloon 30.

In the present invention, the first check valve 40 and the second check valve 50 may be disposed at any portions of the peripheral edges 23 of the films for the outer balloon. Further, a plurality of second check valves 50 may be disposed, as the case requires, by which a plurality of inner balloons 30 can be disposed.

As mentioned above, in the non-latex balloon of the present invention, the second check valve 50 is integrally bonded to the films of the outer balloon 20 and the inner balloon 30 by the heat-sealing of the films, and the gas passageway into the inner balloon 30 is secured. Accordingly, the inner balloon 30 can be easily inflated by filling a gas into the inner balloon 30 through the second check valve 50. Further, the check valves are flat tubular films and no complicated molded product is needed, whereby the production cost is low.

Furthermore, since the first check valve 40 and the second check valve 50 are separately provided, the position for inserting the inner balloon 30 can freely be selected, and a plurality of inner balloons 30 can be arranged, and excellent design effects can be obtained.

In the above embodiment, the inner balloon 30 having the configuration and design of a bird can be seen through the spacing of the birdcage-like printed portions 25, 26 on the surface of the outer balloon 20, and it is possible to provide a balloon having such a design as if the bird is placed in a birdcage.

As described above, according to the present invention, it is possible to provide a non-latex balloon having an outer balloon, an inner balloon, and check valves for filling a gas into these balloons, respectively, integrally formed, and a method for producing it. The non-latex balloon is easily filled with a gas and can float for a long period of time, and provides excellent decorative properties and design properties by the floating inner balloon, whereby it is suitably used for e.g. toy products and advertisement.

What is claimed is:

1. A non-latex balloon having a double balloon structure, which comprises:
an outer balloon made of a plurality of films of which peripheral edges are heat-sealed,
an inner balloon disposed in the outer balloon, made of a plurality of films of which peripheral edges are heat-sealed,
a first check valve of a flat tubular film of which both ends are open-ended, to fill a gas into the outer balloon, wherein the first check valve is disposed between the films of the outer balloon and inwardly inserted through the peripheral edges of the outer balloon and integrally bonded to the outer balloon by heat-sealing the films of the outer balloon, and defines a gas passageway to the inside of the outer balloon, and
a second check valve of a flat tubular film of which both ends are open-ended, to fill a gas into the inner balloon, wherein the second check valve is disposed between the films of the outer balloon and inwardly inserted through the peripheral edges of the outer balloon, and disposed between the films of the inner balloon and inwardly inserted through the peripheral edges of the inner balloon, and wherein the second check valve is integrally bonded to the outer balloon and the inner balloon by heat-sealing the films of the outer balloon and the inner balloon, respectively, and defines a gas passageway to the inside of the inner balloon.

2. The non-latex balloon according to claim 1, wherein each of internal sides of the first and second check valves has a non-heat sealable portion to secure the gas passageway at at least a position or positions at which external sides of the first and second check valves are heat-sealed to the peripheral edges of the outer and inner balloons, respectively.

3. The non-latex balloon according to claim 2, wherein the non-heat sealable portion is formed by coating a heat resistant resin or ink.

4. A method for producing a non-latex balloon of a double balloon structure comprising an outer balloon made of a plurality of films of which peripheral edges are heat-sealed and an inner balloon disposed in the outer balloon, made of a plurality of films of which peripheral edges are heat-sealed, which comprises:
a step for preparing an inner balloon by putting together films for the inner balloon; disposing a second check valve of a flat tubular film of which both ends are open-ended, between the peripheral edges of the films for the inner balloon so that the second check valve is inwardly inserted through the peripheral edges of the films for the inner balloon; and heat-sealing the peripheral edges of the films for the inner balloon which are put together, in such a state that a sealing-preventive means is provided on an internal side of the film of the second check valve to form the inner balloon having the second check valve integrally bonded; and
a step for preparing an outer balloon by putting together films for the outer balloon; disposing the inner balloon between the films for the outer balloon; arranging the second check valve so that it extends outwardly from the peripheral edges of the films for the outer balloon; disposing a first check valve of a flat tubular film of which both ends are open-ended so that the first check valve is inwardly inserted through the peripheral edges of the films of the outer balloon; and heat-sealing the peripheral edges of the films for the outer balloon in such a state that sealing-preventive means are provided on the internal sides of the films of the first and second check valves, to form the outer balloon having the first and second check valves integrally bonded to the outer balloon.

5. The non-latex balloon according to claim 4, wherein the sealing-preventive means is made of a non-heat sealable portion formed on the internal sides of the first and second check valves and at at least a position or positions at which external sides of the first and second check valves are heat-sealed to the peripheral edges of the outer and inner balloons, respectively.

6. The non-latex balloon according to claim 5, wherein the non-heat sealable portion is formed by coating a heat resistant resin or ink.
